(19) United States
(12) Patent Application Publication
(10) Pub. No.: US 2010/0141427 A1
(43) Pub. Date: Jun. 10, 2010

(54) PORTABLE ELECTRONIC SECURITY DEVICE

(76) Inventor: James Nott, Epping (AU)

Correspondence Address: Locke Lord Bissell & Liddell LLP;Attn: IP Docketing, Three World Financial Center, New York, NY, 10281-2101, US

(21) Appl. No.: 12/328,384

(22) Filed: Dec. 4, 2008

(51) Int. Cl. G08B 1/08

(52) U.S. Cl. 340/539.11

(57) ABSTRACT

A two part security system has a portable tamper warning device, adapted to be co-located with a portable object, and incorporating a tamper sensor and an alarm able to be activated by tampering with the physical object; and a separate complementary portable device adapted to be carried by the owner of the physical object; wherein, the tamper warning device is able to detect the presence of the complementary device and is operable to prevent the alarm being activated when the complementary device is within range, but allows the alarm to be activated by a signal from the tamper sensor when the complimentary device is out of range.

### FIELD OF THE INVENTION

This invention relates to detecting theft and preventing loss of valuables.

### BACKGROUND OF THE INVENTION

Opportunistic theft is a fact of life. Many personal security devices offer audible warnings that need manual activation. It can be a nuisance to manually activate and deactivate such an alarm, and it can be dangerous to manually activate an alarm when a robbery is in progress. Furthermore, any delay in activation may result in the alarm being given too late.

### SUMMARY OF THE INVENTION

I have devised an invention that is a two part security system. One aspect of the invention involves a portable tamper warning device, adapted to be co-located with a portable object, and incorporating a tamper sensor and an alarm able to be activated by tampering with the physical object and, a separate complementary portable device adapted to be carried by the owner of the object wherein, the tamper warning device is able to detect the presence of the complementary device and is operable to prevent the alarm being activated when the complementary device is within range, but allows the alarm to be activated by a signal from the tamper sensor when the complimentary device is out of range.

In this way, protection against petty theft and loss of valuable articles, both at home and while out of the home is provided. The implementation of the system described herein relies on both tamper detection and proximity detection to operate. The tamper detection is associated with the valuable being protected, perhaps by being placed on top of it or by being attached to it. Tampering may be detected by use of one or more detectors sensitive to motion, acceleration, vibration or proximity.

One example implementation of the tamper warning device may be housed in a circular housing having a raised dome on the top and incorporating an LED alarm light that runs along slot openings in opposed sides, that also serve to vent an audible alarm. It may include one or more of: a motion detector, a Radio Frequency Identification (RFID) electronics to detect when the complementary portable device is in or out of range, and, a lithium cadmium battery.

When the alarm is activated, it may be automatically de-activated when the complementary device comes into range of the tamper warning device. It may also be automatically de-activated after a short period of time, such as fifteen seconds.

Other implementations of the tamper warning device may further involve one or more of: an LED readout screen to display the times of activation, a camera to record an image at the time of activation, a message transmission system to transmit a message at the time of activation, a means for attachment to valuables by way of any one or more of: a carabiner, a strap with buckle, a clip or, a hook and loop fastener, such as sold under the Velcro brand.

The tamper warning device may emit a periodic warning beep when the battery needs recharging. It may also operate in conjunction with a second tamper warning device in another location, in range, that is automatically and simultaneously activated.

### BRIEF DESCRIPTION OF THE DRAWINGS

An example of the invention will now be described with reference to the accompanying drawings, in which:

FIG. 1 is a pictorial diagram of a two part security system.

FIG. 2 is a portable tamper warning device of the security system.

FIG. 3 is an elevation of the device of FIG. 2.

FIG. 4 is a pictorial diagram of an alternative portable tamper warning device.

### DETAILED DESCRIPTION OF THE INVENTION

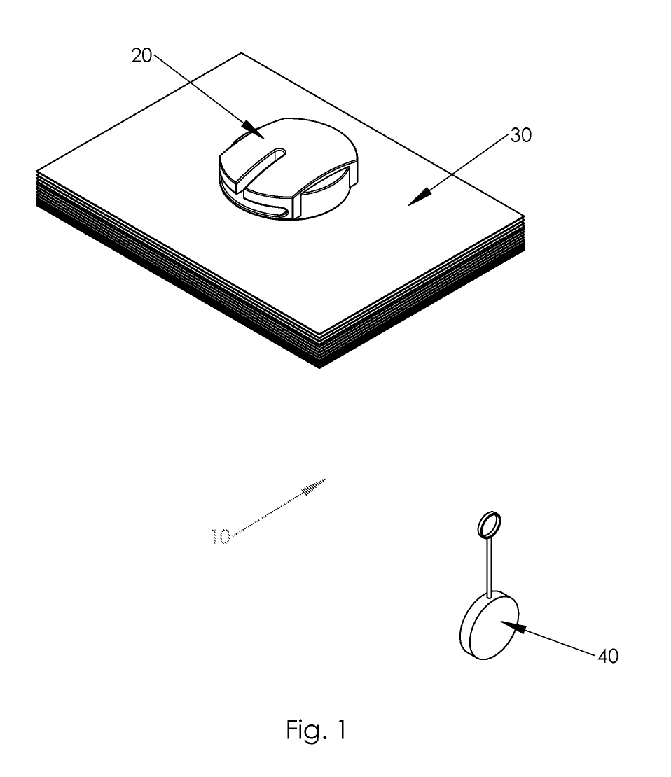

Referring to FIG. 1 the two part security system 10 comprises a portable tamper warning device 20, adapted to be co-located with a portable object 30. And, a separate complementary portable device 40 adapted to be carried by the owner of the object.

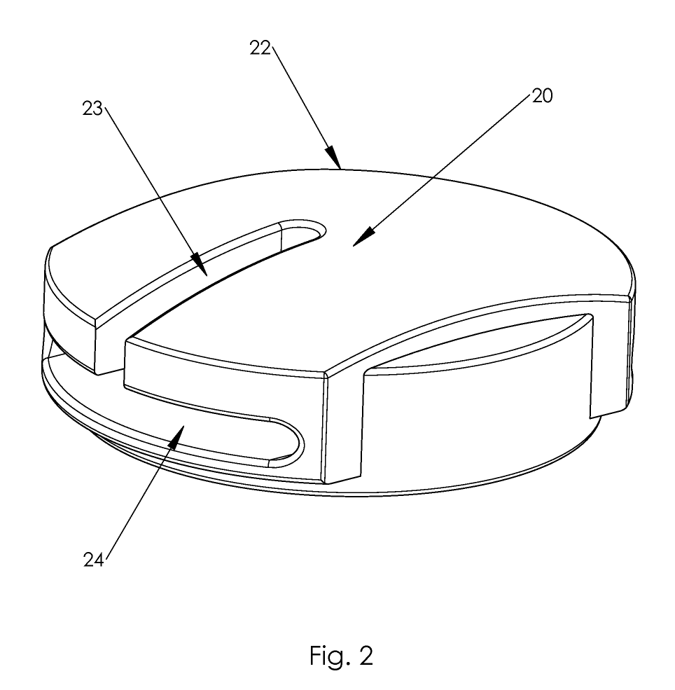

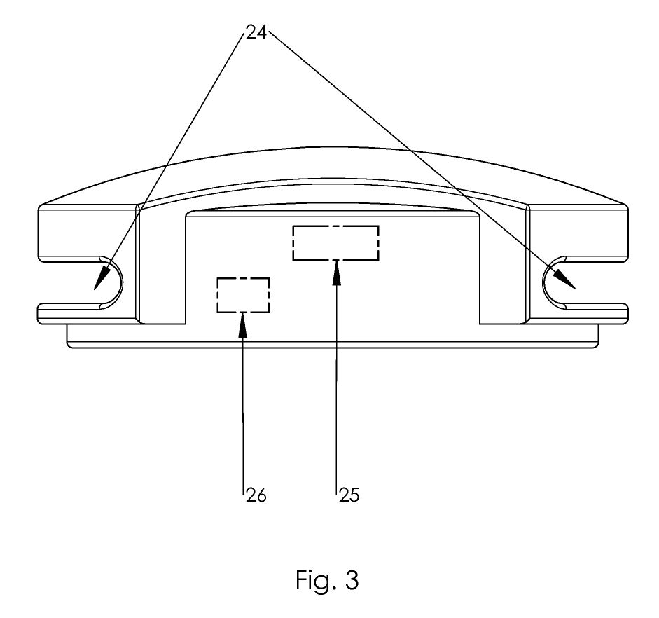

FIGS. 2 and 3 it can be seen that the portable tamper warning device 20 comprises a housing 21 with a domed top 22. A slot 23 runs down the domed top of the device and extends 24 in opposed directions around the sides. Inside there is a motion detector 25 and audible alarm 26. An LED illuminates slot 23 when the device is activated and an alarm sounds by being vented out of slots 24. The device is powered by a rechargeable lithium cadmium battery, and a warning may be given when the battery charge is low.

The tamper warning device 20 is able to detect the presence of the complementary device 40 and is operable to prevent the alarm being activated when the complementary device is within range, but allows the alarm to be activated by a signal from the tamper sensor when the complimentary device is out of range.

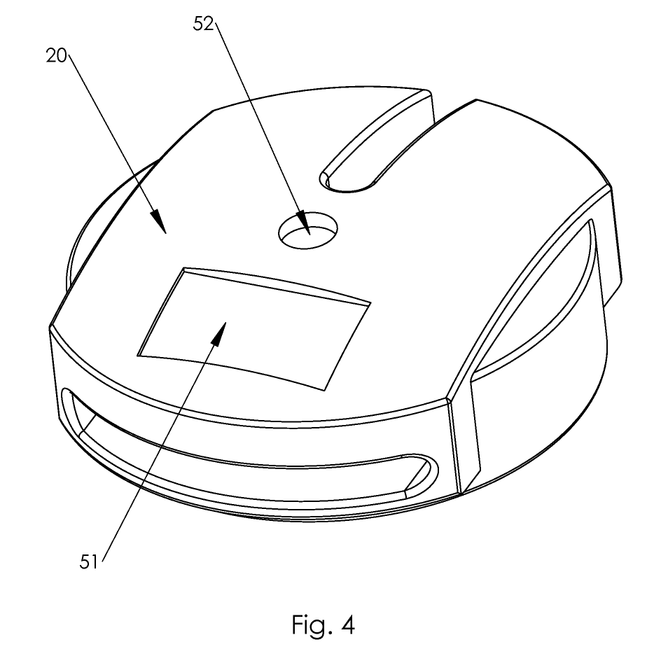

Referring now to FIG. 4, a more sophisticated version of the tamper warning device 20′ also includes an LED screen 51 for readout, and a camera lens 52, on the top of the device.

The portable tamper warning device 20 employs Radio Frequency Identification technology (RFID) to read an RFID tag that constitutes a complementary portable device. While the tag is in range the tamper warning device is disarmed and will not alarm; or if the alarm is being given, it will stop when the tag comes into range. However, when the tag is out of range the tamper warning device is armed and will alarm in response to motion being detected by the detector. In this way the system offers an automatic hands free security alert in appropriate circumstances.

The RFID tag will typically be carried on a key ring or other convenient item that stays with the owner (or other authorised person) of the object being protected, and it may have a range of a few metres. In this way, when the owner is close by they can access the object, say cashbox and documents etc. Conversely, when the authorised person steps outside the range of the tamper warning device, it will automatically re-arm to alarm in the event of unauthorised tampering.

When motion of the tamper warning device is detected and the alarm is given, there is a visual warning, being a bright illuminated LED as well as an audible high pitched alarm. The alarm will be immediate and will automatically cut-off after fifteen seconds duration unless the motion sensor is detecting ongoing motion.

The housing containing the tamper warning device, is made of tamper proof durable material. The device can be attached to valuables by way of a carabiner clip, strap with buckle, standard tape-measure style clip, a hook and loop type fastener arrangement such as sold under the Velcro brand; or simply placed on top of sensitive/confidential documents as a paper weight. It may be manufactured in a range of colours with consideration given for universal fitment capabilities and uses.

The more sophisticated option (of FIG. 4) also incorporates an LED screen to display the precise time of alarms. This information could be transmitted in the form of an SMS message or email. In an office environment for example, detection and apprehension of the offender would be more accurately determined by investigation of people's movements at documented time of misdemeanour. Individual household items protected by the device could be monitored by mobile phones and computers anywhere. A menu facility may be provided by the device to control features of its operation.

A duplicate portable tamper warning device may be used for added security. On disturbance of the primary device, a second identical device hidden close by is also activated in sympathy to issue an alarm and make other security responses, such as sending SMS or taking photos.

Finally, it can be understood that the inventive concept in any of its aspects can be incorporated in many different constructions so that generality of the preceding description is not superseded by the particularity of the attached drawings. Various alterations, Modifications and/or additions may be incorporated into the various constructions and arrangements of parts without departing from the spirit or ambit of the present invention.

What is claimed is:

1. A two part security system comprising:
a portable tamper warning device, adapted to be co-located with a portable object, and incorporating a tamper sensor and an alarm able to be activated by tampering with the physical object; and
a separate complementary portable device adapted to be carried by the owner of the physical object;
wherein, the tamper warning device is able to detect the presence of the complementary device and is operable to prevent the alarm being activated when the complementary device is within range, but allows the alarm to be activated by a signal from the tamper sensor when the complimentary device is out of range.

2. A security system according to claim 1, wherein the tamper warning device is housed in a circular housing having a raised dome on the top and incorporating an LED alarm light that runs along slot openings in opposed sides, and that also serve to vent an audible alarm.

3. A security system according to claim 2, wherein the tamper warning device includes a motion detector.

4. A security system according to claim 3, wherein the tamper warning device includes Radio Frequency Identification (RFID) electronics to detect when the complementary portable device is in or out of range.

5. A security system according to claim 4, wherein the tamper warning device includes a lithium cadmium battery.

6. A security system according to claim 1, wherein when the alarm is activated, it is automatically de-activated when the complementary device comes into range of the tamper warning device.

7. A security system according to claim 1, wherein when the alarm is activated, it is automatically de-activated after a few seconds.

8. A security system according to claim 1, wherein the tamper warning device further comprises an LED readout screen to the times of activation.

9. A security system according to claim 1, wherein the tamper warning device further comprises a camera to record an image at the time of activation.

10. A security system according to claim 1, wherein the tamper warning device further comprises a message transmission system to transmit a message at the time of activation.

11. A security system according to claim 1, wherein the tamper warning device further comprises means for attachment to valuables by way of carabiner clip, strap with buckle, clip or a hook and loop fastener.

12. A security system according claim 1, wherein the tamper warning device further comprises means to emit a periodic warning beep when the battery needs recharging.

13. A security system according to claim 1, wherein the tamper warning device operates in conjunction with a second tamper warning device in another location, in range, that is automatically and simultaneously activated.
